(19) United States
(12) Patent Application Publication
(10) Pub. No.: US 2026/0280208 A1
(43) Pub. Date: Sep. 17, 2026

(54) POWER ADAPTER

(71) Applicant: Chicony Power Technology Co., Ltd., New Taipei City (TW)

(72) Inventor: Chen-Liang LEE, New Taipei City (TW)

(21) Appl. No.: 19/300,688

(22) Filed: Aug. 15, 2025

(30) Foreign Application Priority Data
Mar. 12, 2025 (TW) 114109240

(51) Int. Cl. H01R 31/06; H01R 13/04; H01R 13/506; H01R 27/00; H01R 103/00

(52) U.S. Cl. CPC H01R 31/06; H01R 13/04; H01R 13/506; H01R 27/00; H01R 2103/00

(57) ABSTRACT

A power adapter includes a body and a plug. The body includes a top plate, two opposite sidewalls, a stopper portion, and an engaging portion. The sidewalls, the top plate, and the stopper portion form a receiving groove. The engaging portion is a notch between one sidewall and the stopper portion or a through hole on the sidewall. The plug is disposed in the receiving groove and includes first and second side plates. The first side plate is divided into a stationary portion and a movable portion. The movable portion is provided with a bump for engaging with the engaging portion. A distance between inner surfaces of the sidewalls is greater than or equal to a distance between outer surfaces of the first and second side plates, and is less than a distance between an outer edge of the bump and the outer surface of the second side plate.

### RELATED APPLICATIONS

This application claims priority to Taiwan Application Serial Number 114109240, filed Mar. 12, 2025, the disclosure of which is incorporated herein by reference in its entirety.

### BACKGROUND

### Technical Field

The present disclosure relates to a power adapter.

### Description of Related Art

Some existing power adapters have replaceable plugs, which facilitate users to replace plugs of different specifications in different countries. This is very convenient for users who often travel to different countries. However, the existing power adapters still need to be improved in terms of convenience of disassembling and assembling replaceable plugs and structural reliability.

### SUMMARY

In order to solve the aforementioned technical problem, the present disclosure provides a power adapter with a replaceable plug, which has high structural reliability and makes assembly and disassembly of the replaceable plug more intuitive and convenient.

The present disclosure provides a power adapter, which includes a body and a plug. The body includes a top plate, a first sidewall, a second sidewall, a stopper portion, and an engaging portion. The first sidewall and the second sidewall are located on two opposite sides of the top plate, and form a receiving groove with the top plate and the stopper portion. The engaging portion is a notch between the first sidewall and the stopper portion, or a through hole on the first sidewall. The plug is disposed in the receiving groove and includes a first side plate and a second side plate arranged oppositely. The first side plate is provided with a slot. The slot divides the first side plate into a stationary portion and a movable portion. The movable portion is provided with a bump configured to engage with the engaging portion. An inner surface of the first sidewall and an inner surface of the second sidewall are separated by a first distance. An outer surface of the first side plate and an outer surface of the second side plate are separated by a second distance. An outer edge of the bump and the outer surface of the second side plate are separated by a third distance. The first distance is greater than or equal to the second distance and is less than the third distance.

In one or more embodiments, the first sidewall is provided with a limiting member. The limiting member is located on the inner surface of the first sidewall and protrudes toward the second sidewall. The bump is provided with a recess. The recess and a part of the slot form a chute. The limiting member is slidably matched with the chute.

In one or more embodiments, the first sidewall is provided with a limiting member. The limiting member is located on an upper surface of the first sidewall and protrudes toward the second sidewall. The first side plate is slidably disposed between the limiting member and the top plate.

In one or more embodiments, the plug is provided with a baffle plate adjacent to an inner surface of the movable portion. A distance between an outer surface of the baffle plate and the inner surface of the movable portion is greater than or equal to a width of the bump.

In one or more embodiments, the plug is further provided with a support member connected to the first side plate and the baffle plate.

In one or more embodiments, the support member is located at one-half to one-third of the first side plate from a front edge of the first side plate.

In one or more embodiments, a width of the bump is greater than a width of the movable portion, and/or a length of the movable portion is greater than a length of the bump.

In one or more embodiments, a front end of the bump has a curved surface.

In one or more embodiments, the top plate is provided with a limiting member. The limiting member includes a vertical portion substantially perpendicular to the top plate and a horizontal portion substantially parallel to the top plate. The horizontal portion is connected to the vertical portion and is separated from the top plate by a part or all of the vertical portion. The plug is provided with a limiting groove corresponding to the limiting member.

In one or more embodiments, the limiting member is connected to a surface of the stopper portion facing the receiving groove.

In one or more embodiments, the horizontal portion and the vertical portion form a T-shaped structure or an L-shaped structure.

In one or more embodiments, the bump is disposed at an end of the movable portion and protrudes outward from the movable portion.

In one or more embodiments, the bump of the plug is located below a top wall of the plug, and the top wall covers a portion of the bump.

In one or more embodiments, an upper surface of the bump is substantially flush with an upper surface of a top wall of the plug, and the bump and the top wall are separated by a distance.

In one or more embodiments, the stopper portion is disposed on at least a portion of another side of the top plate.

In one or more embodiments, the stopper portion comprises two or more stoppers.

### BRIEF DESCRIPTION OF THE DRAWINGS

FIG. 1 is a schematic diagram of a power adapter according to an embodiment of the present disclosure.

FIG. 2 is an exploded view of the power adapter in FIG. 1.

FIG. 3 is a sectional view of the power adapter in FIG. 1 taken along a line 3-3′.

FIG. 4 is a sectional view of the power adapter in FIG. 1 taken along a line 4-4′.

FIG. 5 is a schematic diagram of the plug of the power adapter in FIG. 1 viewed from another angle.

FIG. 6 is a sectional view of a power adapter according to another embodiment of the present disclosure.

FIG. 7 is a sectional view of a power adapter according to another embodiment of the present disclosure.

FIG. 8 is a side view of a plug according to another embodiment of the present disclosure.

FIG. 9 is a top view of a power adapter according to another embodiment of the present disclosure.

FIG. 10 is a top view of a power adapter according to another embodiment of the present disclosure.

FIG. 11 is a top view of a power adapter according to another embodiment of the present disclosure.

### DETAILED DESCRIPTION

In order to fully and clearly describe the present invention, various embodiments will be described below with reference to the accompanying drawings. The elements in the drawings are not drawn to scale and are provided merely for illustrating the embodiments. Many practical details are described below to provide a comprehensive understanding of the present invention. Those skilled in the art will appreciate that the present invention may be implemented without one or more of the practical details, and thus these details should not be construed to limit the present invention.

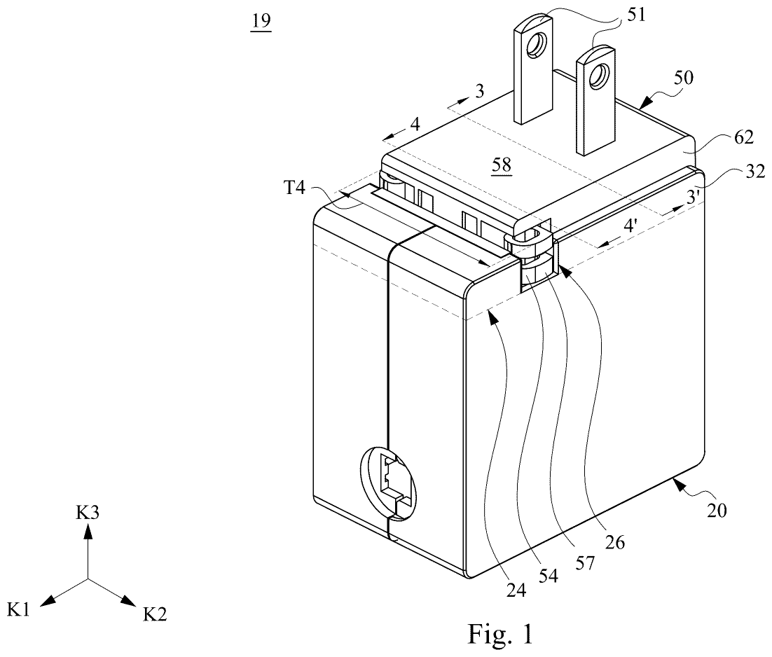

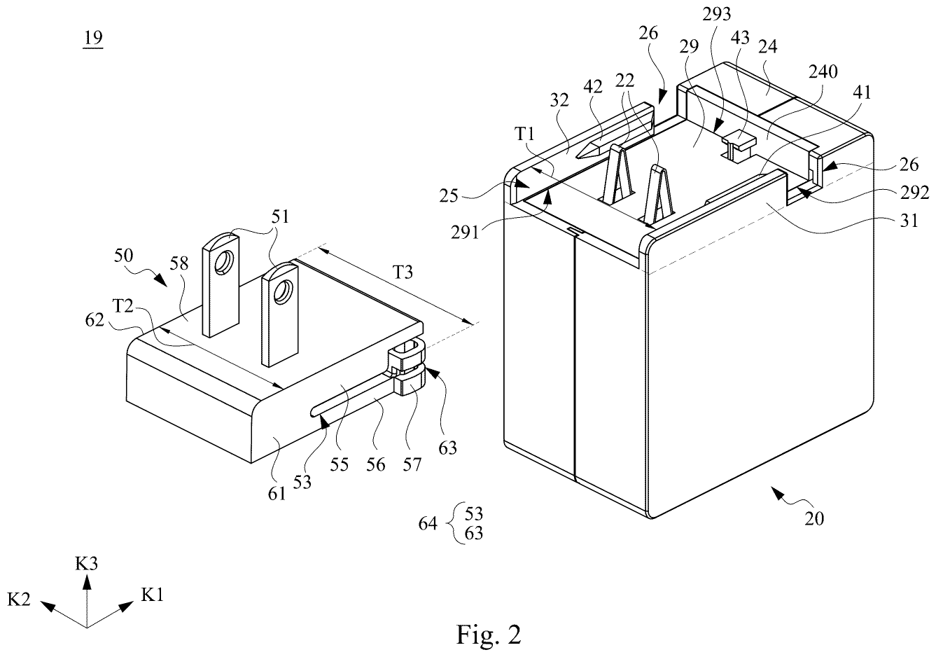

Please refer to FIG. 1 and FIG. 2. The present disclosure provides a power adapter 19, which includes a body 20 and a plug 50 detachably assembled to the body 20. Please refer to FIG. 2, the body 20 includes a top plate 29, a first sidewall 31, a second sidewall 32, a stopper portion 24, and an engaging portion 26. The first sidewall 31 and the second sidewall 32 are located on two opposite sides of the top plate 29, and form a receiving groove 25 with the top plate 29 and the stopper portion 24. Specifically, the first sidewall 31 is located on a first side 291 of the top plate 29, the second sidewall 32 is located on a second side 292 of the top plate 29, and the stopper portion 24 is located on a third side 293 of the top plate 29. The first side 291 and the second side 292 are the two opposite sides of the top plate 29 and are connected to the third side 293. The engaging portion 26 is a notch between the first sidewall 31 and the stopper portion 24.

Please refer to FIG. 1 and FIG. 2, the plug 50 is detachably disposed in the receiving groove 25 of the body 20. The first sidewall 31 and the second sidewall 32 are configured to guide the plug 50 to move into the receiving groove 25 along a first direction K1, to guide the plug 50 to move out of the receiving groove 25 along an opposite direction of the first direction K1, and to prevent the assembled plug 50 from moving along a second direction K2 or an opposite direction of the second direction K2. During assembly, the stopper portion 24 is configured to stop the plug 50 at a desired position. The first direction K1 is substantially parallel to the first side 291 of the top plate 29. The second direction K2 is substantially parallel to the third side 293 of the top plate 29 and is substantially perpendicular to the first direction K1.

Please refer to FIG. 1 and FIG. 2, the plug 50 includes a first side plate 61 and a second side plate 62 arranged oppositely. The first side plate 61 is provided with a slot 53. The slot 53 divides the first side plate 61 into a stationary portion 55 and a movable portion 56. The movable portion 56 is provided with a bump 57 configured to engage with the engaging portion 26. The bump 57 may be disposed at an end of the movable portion 56 and protrude outward from the movable portion 56. Please refer to FIG. 2, an inner surface of the first sidewall 31 and an inner surface of the second sidewall 32 are separated by a first distance T1. An outer surface of the first side plate 61 and an outer surface of the second side plate 62 are separated by a second distance T2. An outer edge of the bump 57 of the first side plate 61 and the outer surface of the second side plate 62 are separated by a third distance T3. The first distance T1 is greater than or equal to the second distance T2 and is less than the third distance T3.

Under the aforementioned structural configuration, the user only needs to apply force to push the plug 50 into the receiving groove 25 along the first direction K1 to assemble the plug 50 onto the body 20. Specifically, when the user applies a force to push the plug 50 into the receiving groove 25 along the first direction K1, a part of the applied force acts on the first sidewall 31 through the bump 57, so that the first sidewall 31 generates a reaction force on the bump 57. The reaction force causes the movable portion 56 to bend inward and store elastic force (i.e., elastic deformation), so that the bump 57 enters the receiving groove 25 and abuts against the inner surface of the first sidewall 31. Then, the bump 57 continues to abut against the inner surface of the first sidewall 31 and moves toward the stopper portion 24. When the bump 57 moves to a position corresponding to the engaging portion 26, the movable portion 56 returns to its original state and releases the elastic force, so that the bump 57 automatically engages with the engaging portion 26, thereby completing and assembly of the plug 50 and the body 20. The bump 57 and the engaging portion 26 are configured to prevent the assembled plug 50 from moving along the first direction K1 or the opposite direction of the first direction K1, thereby preventing the assembled plug 50 from separating from the receiving groove 25. When the user wants to remove the plug 50 from the body 20, the user only needs to press the bump 57 inward to disengage the bump 57 from the engaging portion 26, and then push the plug 50 out of the receiving groove 25 along the opposite direction of the first direction K1.

Please refer to FIG. 1, in an embodiment, in the first direction K1, a length of the movable portion 56 is greater than a length of the bump 57, thereby increasing elasticity of the movable portion 56. In an embodiment, in a third direction K3, a width of the bump 57 is greater than a width of the movable portion 56, thereby increasing stability of the bump 57 engaging with the engaging portion 26. The third direction K3 is substantially perpendicular to the top plate 29 and substantially perpendicular to the first direction K1 and the second direction K2. In an embodiment, a front end of the bump 57 has a curved surface 54 to reduce resistance when the plug 50 is pushed into the receiving groove 25.

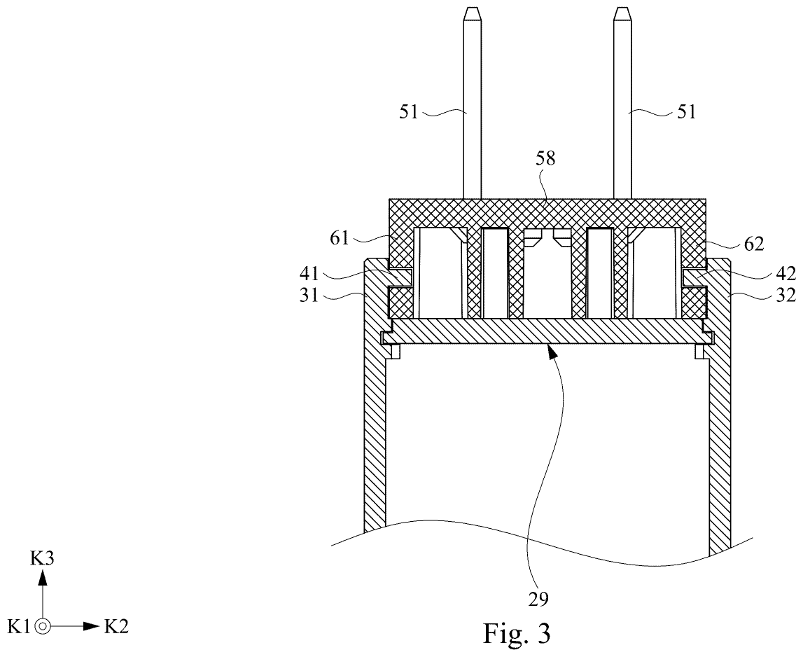

Please refer to FIG. 2 and FIG. 3, in an embodiment, the first sidewall 31 of the body 20 is provided with a first limiting member 41. The first limiting member 41 is located on the inner surface of the first sidewall 31 and protrudes toward the second sidewall 32. The first limiting member 41 may be a slide rail extending along the first direction K1. The bump 57 of the first side plate 61 of the plug 50 is provided with a recess 63. The recess 63 and a part of the slot 53 form a chute 64. Specifically, the recess 63 of the bump 57 extends along the first direction K1, and forms the chute 64 with a part of the slot 53 extending along the first direction K1. That is, the chute 64 extends along the first direction K1. In the third direction K3, the recess 63 and the slot 53 may be aligned with each other and may have the same or similar width. The first limiting member 41 is slidably matched with the chute 64. The first limiting member 41 and the chute 64 are configured to guide the plug 50 to slide into the receiving groove 25 along the first direction K1 during assembly, and to guide the plug 50 to slide out of the receiving groove 25 along the opposite direction of the first direction K1 during disassembly. After assembly, the first limiting member 41 is located in a portion of the slot 53 extending along the first direction K1, so as to prevent the assembled plug 50 from moving along the third direction K3 and separating from the receiving groove 25.

Please refer to FIG. 1 and FIG. 2, in an embodiment, the second side plate 62 of the plug 50 may have the same structure as the first side plate 61. That is, the second side plate 62 may also be provided with the same slot 53, stationary portion 55, movable portion 56, and bump 57. The body 20 may include another engaging portion 26, which is a notch between the second sidewall 32 and the stopper portion 24, and is configured to engage with the bump 57 of the second side plate 62. Please refer to FIG. 1, when the second side plate 62 has the bump 57, an outer edge of the bump 57 of the second side plate 62 and the outer surface of the first side plate 61 are separated by a fourth distance T4. Please refer to FIG. 1 and FIG. 2, the first distance T1 is greater than or equal to the second distance T2 and is less than the fourth distance T4.

Please refer to FIG. 2 and FIG. 3, in an embodiment, the second sidewall 32 of the body 20 may be provided with a second limiting member 42. The second limiting member 42 is located on the inner surface of the second sidewall 32 and protrudes toward the first sidewall 31. The bump 57 of the second side plate 62 of the plug 50 is provided with another recess 63, which forms another chute 64 with a part of the slot 53 of the second side plate 62 extending along the first direction K1. The second limiting member 42 is configured to slide in the corresponding chute 64 to further guide the plug 50 to slide into the receiving groove 25 along the first direction K1 and to slide out of the receiving groove 25 along the opposite direction of the first direction K1. After assembly, the second limiting member 42 is located in a portion of the slot 53 extending along the first direction K1, thereby preventing the plug 50 from moving along the third direction K3 and separating from the receiving groove 25.

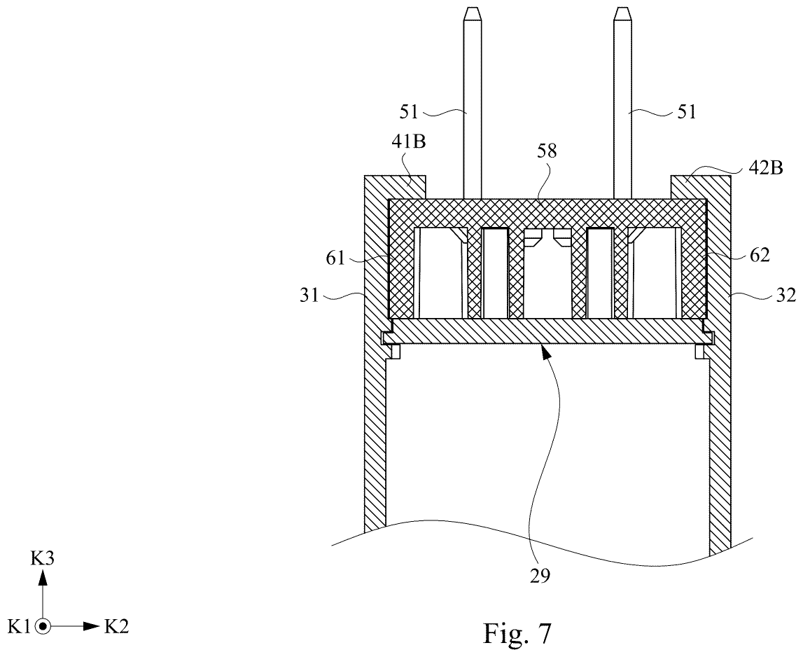

Please refer to FIG. 7, which is a sectional view of a power adapter according to another embodiment of the present disclosure. In this embodiment, the first sidewall 31 of the body 20 is provided with a first limiting member 41B. The first limiting member 41B is located on an upper surface of the first sidewall 31 and protrudes toward the second sidewall 32. The second sidewall 32 of the body 20 is provided with a second limiting member 42B. The second limiting member 42B is located on an upper surface of the second sidewall 32 and protrudes toward the first sidewall 31. The plug 50 is located between the first limiting member 41B and the top plate 29, and between the second limiting member 42B and the top plate 29. The first limiting member 41B, the first sidewall 31, and the top plate 29 form a guide groove. The second limiting member 42B, the second sidewall 32, and the top plate 29 form another guide groove. These two guide grooves are configured to guide the plug 50 to slide into the receiving groove 25 along the first direction K1 and slide out of the receiving groove 25 along the opposite direction of the first direction K1, and to prevent the assembled plug 50 from moving along the third direction K3 and separating from the receiving groove 25. Specifically, the first side plate 61 of the plug 50 slides between the first limiting member 41B and the top plate 29, and the second side plate 62 of the plug 50 slides between the second limiting member 42B and the top plate 29. After assembly, the first limiting member 41B and the second limiting member 42B are located on/above a top wall 58 of the plug 50. In this embodiment, the bump 57 of the first side plate 61 and the bump 57 of the second side plate 62 do not need to be provided with a recess.

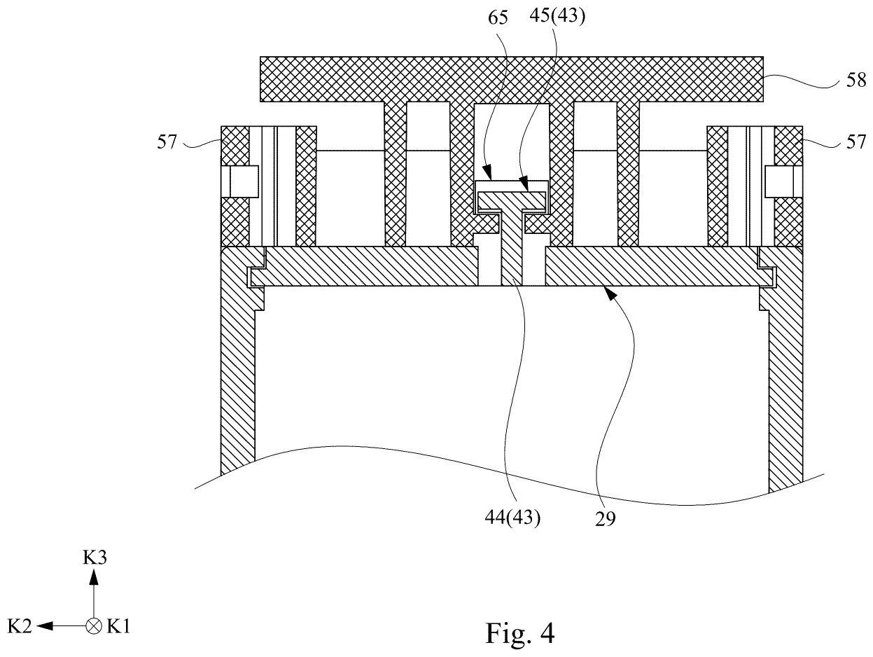

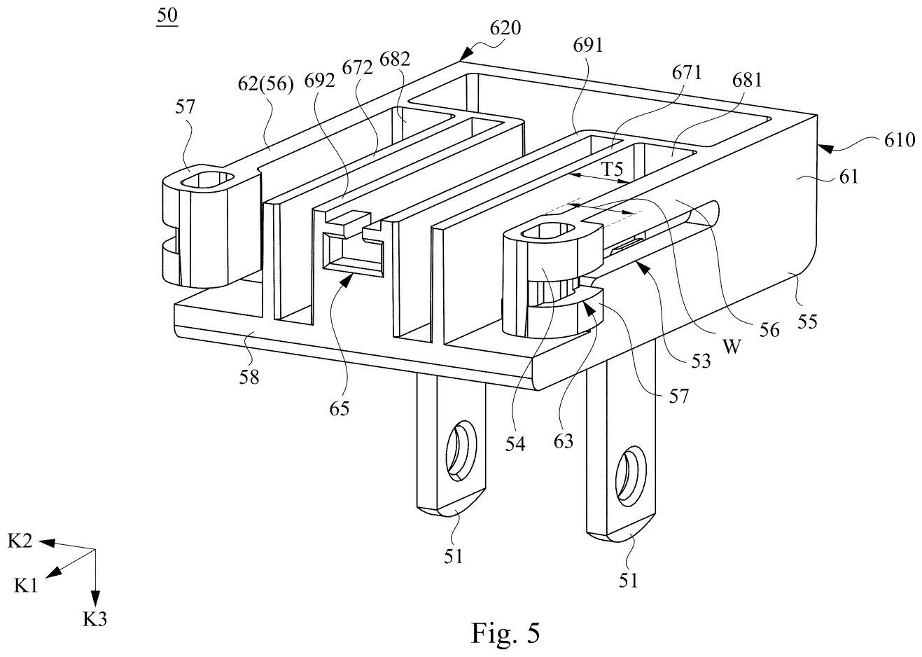

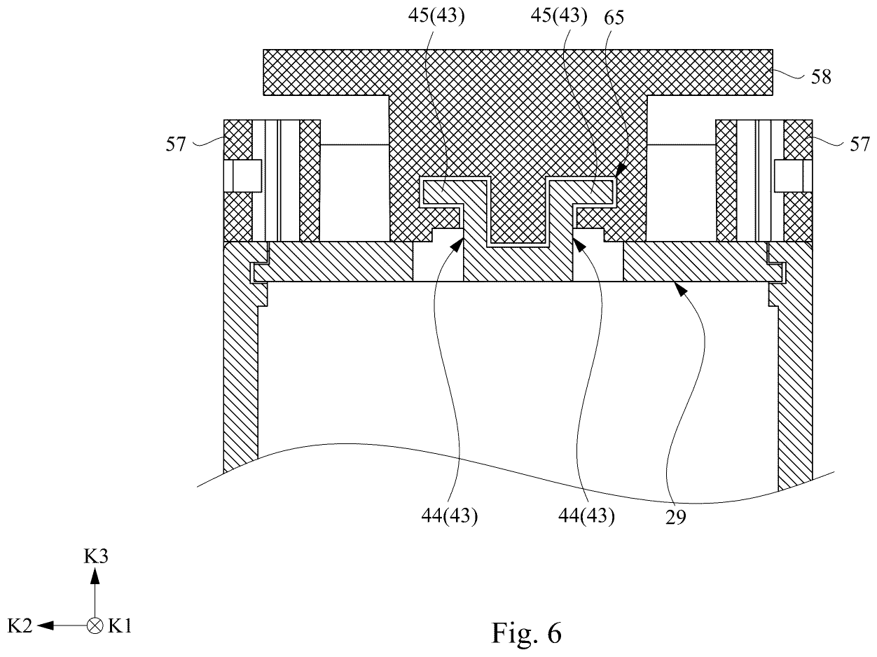

Please refer to FIG. 2, FIG. 4, FIG. 5, and FIG. 6, in some embodiments, the top plate 29 of the body 20 is further provided with at least one third limiting member 43. Each third limiting member 43 includes at least one vertical portion 44 substantially perpendicular to the top plate 29 and at least one horizontal portion 45 substantially parallel to the top plate 29. The at least one horizontal portion 45 is connected to one vertical portion 44, and is separated from the top plate 29 by at least a part of the vertical portion 44. The plug 50 is provided with at least one limiting groove 65 corresponding to the at least one third limiting member 43. A shape of the limiting groove 65 matches a shape of the third limiting member 43, so that the third limiting member 43 can be inserted into the limiting groove 65 along the first direction K1 and can be removed from the limiting groove 65 along the opposite direction of the first direction K1. The horizontal portion 45 prevents the assembled plug 50 from moving along the third direction K3, and the vertical portion 44 prevents the assembled plug 50 from moving along the second direction K2 or the opposite direction of the second direction K2.

Please refer to FIG. 2, FIG. 4, and FIG. 5, in an embodiment, the top plate 29 is provided with one third limiting member 43, which includes one vertical portion 44 and one horizontal portion 45. The horizontal portion 45 is separated from the top plate 29 by an entirety of the vertical portion 44. The horizontal portion 45 and the vertical portion 44 form a T-shaped structure. That is, the third limiting member 43 is a T-shaped structure.

Please refer to FIG. 6, in another embodiment, the top plate 29 is provided with two third limiting members 43. Each of the third limiting members 43 includes one vertical portion 44 and one horizontal portion 45. The horizontal portion 45 is separated from the top plate 29 by an entirety of the vertical portion 44. The horizontal portion 45 and the vertical portion 44 form an L-shaped structure. That is, the third limiting member 43 includes two L-shaped structures. In other embodiments, the third limiting member 43 may include one or more structures of E-shape, F-shape, H-shape, or other suitable geometric shapes. In addition, the top plate 29 may also be provided with a plurality of the third limiting members 43 having different geometric shapes or sizes.

Please refer to FIG. 2, in an embodiment, the third limiting member 43 is connected to a surface 240 of the stopper portion 24 facing the receiving groove 25. In other embodiments, the third limiting member 43 may be spaced apart from the stopper portion 24.

Please refer to FIG. 5, in an embodiment, the plug 50 is further provided with a first baffle plate 671 adjacent to an inner surface of the movable portion 56 of the first side plate 61. The first baffle plate 671 is substantially parallel to the first side plate 61. In the second direction K2, a fifth distance T5 between an outer surface of the first baffle plate 671 and the inner surface of the movable portion 56 of the first side plate 61 is greater than or equal to a width W of the bump 57. The outer surface of the first baffle plate 671 is a surface of the first baffle plate 671 away from a center of the plug 50. The inner surface of the movable portion 56 of the first side plate 61 is a surface of the movable portion 56 close to the center of the plug 50. The first baffle plate 671 is configured to prevent the movable portion 56 of the first side plate 61 from being excessively bent inward and from being broken. In another embodiment, when the second side plate 62 is provided with the movable portion 56 and the bump 57, the plug 50 may be provided with a second baffle plate 672 adjacent to an inner surface of the movable portion 56 of the second side plate 62 to prevent the movable portion 56 of the second side plate 62 from being excessively bent inward and from being broken.

Please refer to FIG. 5, in an embodiment, the plug 50 is further provided with a first support member 681. The first support member 681 is connected to the first side plate 61 and the first baffle plate 671 to support the first side plate 61 and the first baffle plate 671, thereby increasing the structural stability of the plug 50 and reducing the risk of the movable portion 56 of the first side plate 61 being broken due to inward bending. The first support member 681 may be located at a position between one-half and one-third of the first side plate 61 from a front edge 610 of the first side plate 61. In an embodiment, the first support member 681 may be close to an end of the slot 53 of the first side plate 61.

Please refer to FIG. 5, in another embodiment, the plug 50 may be provided with a second support member 682. The second support member 682 is connected to the second side plate 62 and the second baffle plate 672 to support the second side plate 62 and the second baffle plate 672, thereby increasing the structural stability of the plug 50 and reducing the risk of the movable portion 56 of the second side plate 62 being broken due to inward bending. The second support member 682 may be located at a position between half and one-third of the second side plate 62 from a front edge 620 of the second side plate 62. In an embodiment, the second support member 682 may be close to an end of the slot 53 of the second side plate 62. In this embodiment, the second support member 682 is disposed at a position corresponding to the first support member 681, but is not limited thereto.

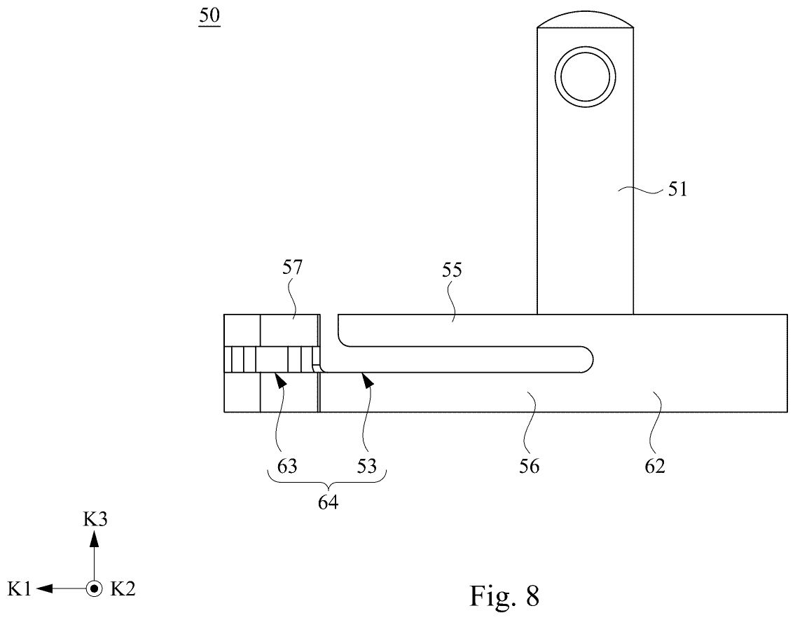

Please refer to FIG. 2 and FIG. 5, in an embodiment, the bump 57 of the plug 50 is located below the top wall 58, and the top wall 58 covers a portion of the bump 57. Please refer to FIG. 8, in another embodiment, an upper surface of the bump 57 is substantially flush with an upper surface of the top wall 58, and the bump 57 and the top wall 58 are separated by a distance.

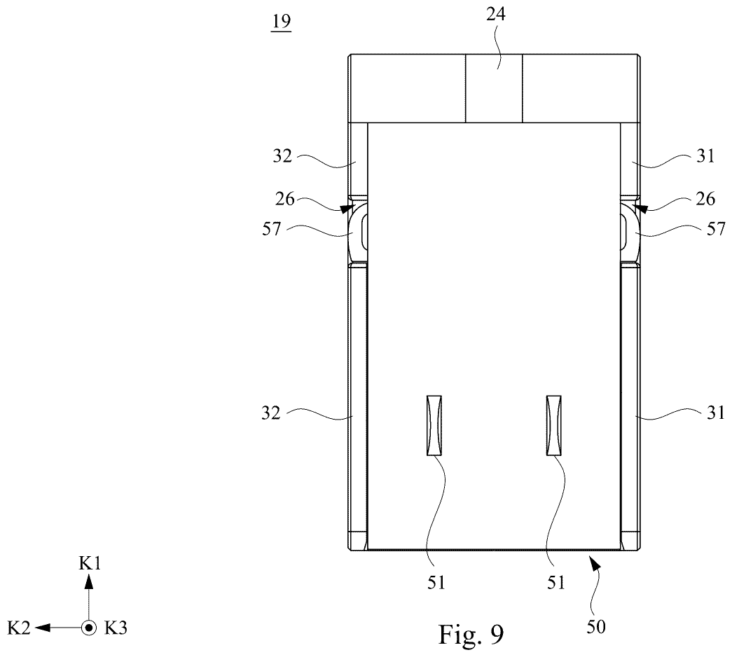

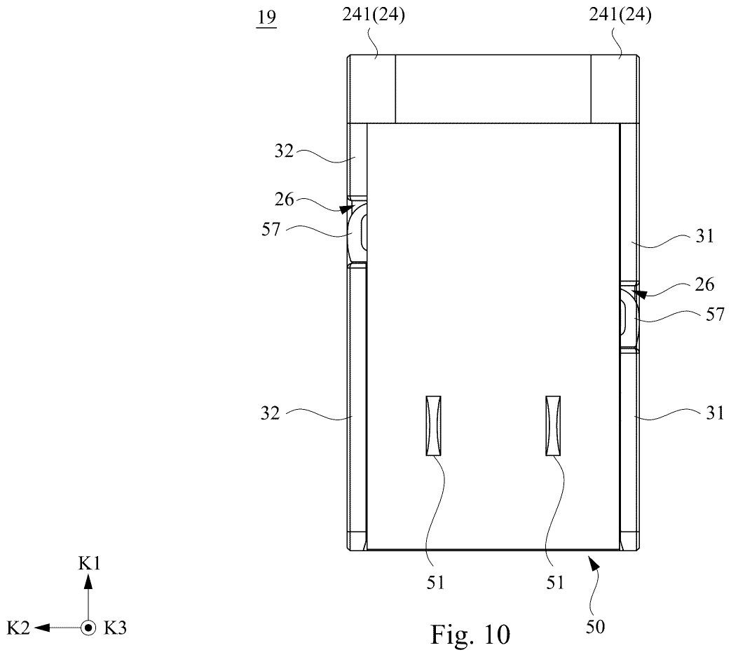

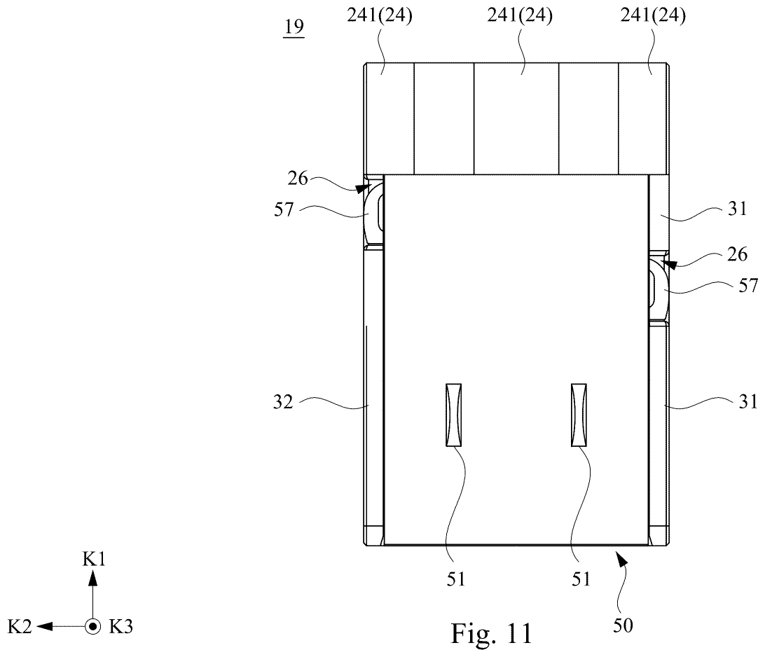

Please refer to FIG. 2, in an embodiment, the stopper portion 24 is disposed on the third side 293 of the top plate 29 and extends from the first side 291 of the top plate 29 to the second side 292 of the top plate 29. That is, the stopper portion 24 is disposed on an entirety of the third side 293 of the top plate 29. Please refer to FIG. 9, in another embodiment, the stopper portion 24 is disposed on a portion of the third side 293 of the top plate 29. In this embodiment, the stopper portion 24 is disposed on a middle portion of the third side 293 of the top plate 29, but is not limited thereto. The stopper portion 24 may also be close to or adjacent to the first side 291 or the second side 292 of the top plate 29. Please refer to FIG. 10 and FIG. 11, in other embodiments, the stopper portion 24 may include two or more stoppers 241. As shown in FIG. 10, the stopper portion 24 includes two stoppers 241, which are respectively adjacent to the first side 291 and the second side 292 of the top plate 29. As shown in FIG. 11, the stopper portion 24 includes three stoppers 241, which are arranged at intervals and are respectively located at both ends and the middle portion of the third side 293 of the top plate 29. The shape, size, and/or height of the aforementioned stopper portion 24 or stopper 241 may be adjusted according to actual needs, as long as the stopper portion 24 or the stopper 241 can assist the plug 50 to stop at a desired position during assembly.

Please refer to FIG. 2, in the aforementioned embodiments, the engaging portion 26 is a notch between the first sidewall 31 and the stopper portion 24, or a notch between the second sidewall 32 and the stopper portion 24. Please refer to FIG. 9, in another embodiment, the engaging portion 26 may be a through hole on the first sidewall 31, or a through hole on the second sidewall 32. The engaging portion 26 may divide the first sidewall 31 or the second sidewall 32 into two parts.

When the body 20 has two engaging portions 26, there are the following embodiments. Please refer to FIG. 2, in an embodiment, the two engaging portions 26 are a notch between the first sidewall 31 and the stopper portion 24, and a notch between the second sidewall 32 and the stopper portion 24. Please refer to FIG. 9 and FIG. 10, in some embodiments, the two engaging portions 26 are a through hole on the first sidewall 31, and a through hole on the second sidewall 32. Please refer to FIG. 9, the two engaging portions 26 may be aligned in the first direction K1. Please refer to FIG. 10, the two engaging portions 26 may be misaligned in the first direction K1. The positions of the two engaging portions 26 in the first direction K1 may be adjusted according to actual needs. Please refer to FIG. 11, in an embodiment, the two engaging portions 26 are a through hole on the first sidewall 31, and a notch between the second sidewall 32 and the stopper portion 24. On the contrary, the two engaging portions 26 may also be a notch between the first sidewall 31 and the stopper portion 24, and a through hole on the second sidewall 32.

Various embodiments of the stopper portion 24 and various embodiments of the engaging portion 26 are listed above. FIG. 2 and FIGS. 9-11 illustrate four combinations of the stopper portion 24 and the engaging portion 26, but are not limited thereto. Different combinations may be made according to actual needs.

Please refer to FIG. 2, in an embodiment, the body 20 further includes two conductive springs 22 penetrating through the top plate 29, and the plug 50 further includes two pins 51 penetrating through the top wall 58. When the plug 50 is assembled to the body 20, the two conductive springs 22 contact the two pins 51. Please refer to the above, the first sidewall 31, the second sidewall 32, the stopper portion 24, the engaging portion 26, the bump 57, the first limiting member 41 or 41B, the second limiting member 42 or 42B, the slot 53, the third limiting member 43, and/or the limiting groove 65 limit movement of the assembled plug 50 in the first direction K1, the opposite direction of the first direction K1, the second direction K2, the opposite direction of the second direction K2, and/or the third direction K3, so that the plug 50 is more stably combined with the body 20, and the pins 51 are more stably in contact with the conductive springs 22.

Please refer to FIG. 5, in some embodiments, the plug 50 further includes a first partition 691 and a second partition 692 respectively located on two opposite sides of the limiting groove 65. A portion of one of the two pins 51 of the plug 50 is located between the first partition 691 and the first baffle plate 671, and a portion of the other one of the two pins 51 is located between the second partition 692 and the second baffle plate 672. When the plug 50 is assembled with the body 20, one of the two conductive springs 22 of the body 20 is located between the first partition 691 and the first baffle plate 671 and contacts the corresponding pin 51, and the other one of the two conductive springs 22 is located between the second partition 692 and the second baffle plate 672 and contacts the corresponding pin 51. In an embodiment, the first support member 681 may extend to and be connected to the first partition 691 to support the first partition 691. The second support member 682 may extend to and be connected to the second partition 692 to support the second partition 692.

In the above embodiments, the plug 50 is of Taiwan specification, but is not limited thereto. The plug 50 may also be of a specification of another country, such as the United States, Europe, China, the United Kingdom, Australia, South Korea, or India. According to the specification of the plug 50, the pins 51 have corresponding quantity, shape, position, and angle, and other components such as the first partition 691 and the second partition 692 are also adaptively designed.

Although the present disclosure has been described by way of the exemplary embodiments above, the present disclosure is not to be limited to those embodiments. Any person skilled in the art can make various changes and modifications without departing from the spirit and the scope of the present disclosure. Therefore, the protective scope of the present disclosure shall be the scope of the claims as attached.

What is claimed is:

1. A power adapter, comprising:
a body comprising a top plate, a first sidewall, a second sidewall, a stopper portion, and an engaging portion, wherein the first sidewall and the second sidewall are located on two opposite sides of the top plate, and form a receiving groove with the top plate and the stopper portion, and the engaging portion is a notch between the first sidewall and the stopper portion, or a through hole on the first sidewall; and
a plug disposed in the receiving groove and comprising a first side plate and a second side plate arranged oppositely, wherein the first side plate is provided with a slot, the slot divides the first side plate into a stationary portion and a movable portion, and the movable portion is provided with a bump configured to engage with the engaging portion,
wherein an inner surface of the first sidewall and an inner surface of the second sidewall are separated by a first distance, an outer surface of the first side plate and an outer surface of the second side plate are separated by a second distance, an outer edge of the bump and the outer surface of the second side plate are separated by a third distance, and the first distance is greater than or equal to the second distance and is less than the third distance.

2. The power adapter of claim 1, wherein the first sidewall is provided with a limiting member, the limiting member is located on the inner surface of the first sidewall and protrudes toward the second sidewall, the bump is provided with a recess, the recess and a part of the slot form a chute, and the limiting member is slidably matched with the chute.

3. The power adapter of claim 1, wherein the first sidewall is provided with a limiting member, the limiting member is located on an upper surface of the first sidewall and protrudes toward the second sidewall, and the first side plate is slidably disposed between the limiting member and the top plate.

4. The power adapter of claim 1, wherein the plug is provided with a baffle plate adjacent to an inner surface of the movable portion, and a distance between an outer surface of the baffle plate and the inner surface of the movable portion is greater than or equal to a width of the bump.

5. The power adapter of claim 4, wherein the plug is further provided with a support member connected to the first side plate and the baffle plate.

6. The power adapter of claim 5, wherein the support member is located at one-half to one-third of the first side plate from a front edge of the first side plate.

7. The power adapter of claim 1, wherein a width of the bump is greater than a width of the movable portion, or a length of the movable portion is greater than a length of the bump.

8. The power adapter of claim 1, wherein a front end of the bump has a curved surface.

9. The power adapter of claim 1, wherein the top plate is provided with a limiting member, the limiting member comprises a vertical portion substantially perpendicular to the top plate and a horizontal portion substantially parallel to the top plate, the horizontal portion is connected to the vertical portion and is separated from the top plate by a part or all of the vertical portion, the plug is provided with a limiting groove corresponding to the limiting member.

10. The power adapter of claim 9, wherein the limiting member is connected to a surface of the stopper portion facing the receiving groove.

11. The power adapter of claim 9, wherein the horizontal portion and the vertical portion form a T-shaped structure or an L-shaped structure.

12. The power adapter of claim 1, wherein the bump is disposed at an end of the movable portion and protrudes outward from the movable portion.

13. The power adapter of claim 1, wherein the bump of the plug is located below a top wall of the plug, and the top wall covers a portion of the bump.

14. The power adapter of claim 1, wherein an upper surface of the bump is substantially flush with an upper surface of a top wall of the plug, and the bump and the top wall are separated by a distance.

15. The power adapter of claim 1, wherein the stopper portion is disposed on at least a portion of another side of the top plate.

16. The power adapter of claim 15, wherein the stopper portion comprises two or more stoppers.
